(19) United States
(12) Patent Application Publication
(10) Pub. No.: US 2026/0073222 A1
(43) Pub. Date: Mar. 12, 2026

(54) AI-DRIVEN ADAPTIVE META-LEARNING FRAMEWORK FOR SELF-EVOLVING NEURAL ARCHITECTURE OPTIMIZATION

(71) Applicants: Ramesh Inala, Hackensack, NJ (US); Ravi Shankar Garapati, Tyngsboro, MA (US); Avinash Reddy Aitha, Glendale, AZ (US); Venkata Bhardwaj Komaragiri, Frederick, MD (US); Vijaya Rama Raju Gottimukkala, Aldie, VA (US); Mahesh Recharla, Holly Springs, NC (US); Pallav kumar Kaulwar, Frisco, TX (US); Sneha Singireddy, Peoria, AZ (US); Sateesh Kumar Rongali, Woodbridge, NJ (US); Keerthi Amistapuram, Brambleton, VA (US); Dwaraka Nath Kummari, Ellicott, MD (US); Goutham Kumar Sheelam, Murrieta, CA (US); Durga Bramarambika Sailaja Varri, Woodbridge, NJ (US)

(72) Inventors: Ramesh Inala, Hackensack, NJ (US); Ravi Shankar Garapati, Tyngsboro, MA (US); Avinash Reddy Aitha, Glendale, AZ (US); Venkata Bhardwaj Komaragiri, Frederick, MD (US); Vijaya Rama Raju Gottimukkala, Aldie, VA (US); Mahesh Recharla, Holly Springs, NC (US); Pallav kumar Kaulwar, Frisco, TX (US); Sneha Singireddy, Peoria, AZ (US); Sateesh Kumar Rongali, Woodbridge, NJ (US); Keerthi Amistapuram, Brambleton, VA (US); Dwaraka Nath Kummari, Ellicott, MD (US); Goutham Kumar Sheelam, Murrieta, CA (US); Durga Bramarambika Sailaja Varri, Woodbridge, NJ (US)

(21) Appl. No.: 19/389,108

(22) Filed: Nov. 14, 2025

(51) Int. Cl. G06N 3/082; G06N 3/092

(52) U.S. Cl. CPC G06N 3/082; G06N 3/092

(57) ABSTRACT

The invention provides an AI-driven adaptive meta-learning framework for self-evolving neural architecture optimization. The system employs a meta-controller network trained via reinforcement learning to autonomously generate and refine neural architectures. An adaptive reward engine and a self-evolution module enable the system to evolve its optimization policies dynamically across multiple tasks and environments. The invention reduces human dependency in model design, enhances generalization, and facilitates continuous AI evolution through reinforced meta-learning principles.

### TECHNICAL FIELD

The present invention relates to artificial intelligence (AI) and machine learning (ML), more particularly to a system and method for dynamically optimizing neural network architectures using reinforced meta-learning principles. The invention further relates to automated architecture search, model evolution, and hyperparameter tuning in deep neural networks, where the optimization process itself learns to adapt and improve over time based on environmental feedback.

### BACKGROUND OF THE INVENTION

Traditional deep learning models rely on fixed architectures that are manually designed through human expertise and trial-and-error experimentation. Although neural architecture search (NAS) techniques have automated parts of this process, they often remain computationally expensive and require significant human supervision.

Recent approaches, such as reinforcement learning-based NAS and evolutionary algorithms, have demonstrated progress; however, they struggle to generalize across multiple domains or tasks. Their optimization objective is static and incapable of adapting dynamically as new data distributions emerge. Moreover, they lack self-evolving mechanisms that can learn to modify their search strategies based on prior optimization outcomes.

There exists, therefore, a need for a self-evolving meta-learning framework that continuously improves the process of architecture optimization itself—learning how to learn optimal architectures under changing data environments, computational budgets, and performance constraints. Such a system would eliminate extensive manual interventions, reduce training costs, and achieve superior adaptability and generalization.

### SUMMARY OF THE INVENTION

The present invention provides an adaptive self-evolving neural architecture optimization framework that leverages reinforced meta-learning to autonomously design, evaluate, and evolve deep neural network architectures. Unlike conventional NAS systems, the proposed framework integrates multi-agent reinforcement learning, meta-policy adaptation, and continual evolution modules that together enable an AI system to refine its own learning strategy.

According to one embodiment of the invention, the system comprises:
1. A Meta-Controller Network (MCN) trained through reinforcement signals to generate candidate neural architectures.
2. A Performance Evaluator Module (PEM) that assesses each architecture's accuracy, efficiency, and resource usage.
3. An Adaptive Reward Engine (ARE) that dynamically redefines reward signals based on environmental conditions and long-term performance trends.
4. A Self-Evolution Module (SEM) that applies neural mutation and crossover operations based on meta-gradient feedback, enabling continual adaptation across tasks.

The present architecture collectively allows for continuous architectural innovation—producing models that evolve autonomously in response to changes in data, performance requirements, or computational resources. The invention thus provides a robust mechanism for AI-driven architecture optimization without explicit human supervision.

### BRIEF DESCRIPTION OF THE DRAWINGS

The objectives as described above as well as the uniqueness of the proposed technology along with its advantages are better appreciated by referring to the following illustrative and non-limiting detailed description of the present invention along with the following schematic diagrams, wherein:

FIG. 1 illustrates the overall system architecture of the AI-Driven Adaptive Meta-Learning Framework for Self-Evolving Neural Architecture Optimization according to one embodiment of the invention.

The drawings described herein are for illustration purposes only and are not intended to limit the scope of the present invention in any way.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The present invention relates to AI-driven adaptive meta-learning framework for self-evolving neural architecture optimization. The system employs a meta-controller network trained via reinforcement learning to autonomously generate and refine neural architectures.

According to one embodiment of the invention, the present disclosure provides a self-evolving artificial intelligence framework designed to automate and continuously improve the process of neural architecture optimization through reinforced meta-learning. The invention introduces a hierarchical learning structure in which the system not only learns optimal neural architectures for specific tasks but also learns how to learn better optimization strategies over time. The invention therefore represents a major shift from static architecture search to a dynamic self-improving optimization ecosystem, where every learning cycle enhances the system's capacity for future adaptation.

The framework integrates reinforcement learning (RL), evolutionary computation, and meta-learning principles into a unified adaptive intelligence. The design supports both centralized cloud implementations and decentralized or edge-based deployment models, enabling scalability from small embedded devices to large distributed clusters. The system continuously evolves by monitoring task performance, computational resource constraints, and data drift conditions, thereby ensuring long-term efficiency and robustness in dynamic environments.

Meta-Controller Network (MCN): According to one embodiment, the Meta-Controller Network (MCN) forms the central decision-making entity of the invention. It is a neural policy generator responsible for producing architectural blueprints of child neural networks (also referred to as candidate models). The MCN may be implemented as a recurrent neural network (RNN), long short-term memory (LSTM), gated recurrent unit (GRU), or a transformer-based attention architecture capable of encoding sequences representing layer configurations, activation types, connection patterns, and optimization hyperparameters.

Each step in the MCN corresponds to the selection of a design element (e.g., convolutional layer, kernel size, normalization method, activation function). The MCN outputs a vector or token sequence representing a complete neural architecture. Once the sequence is generated, it is passed to the Architecture Instantiation Engine (AIE) that constructs the corresponding deep learning model graph for evaluation. The MCN's parameters (weights and biases) are optimized through reinforcement learning such that architectures yielding higher validation performance or better efficiency receive higher cumulative rewards. Over successive iterations, the MCN learns a policy that favors architectures more likely to generalize effectively across unseen tasks or datasets.

Architecture Instantiation Engine (AIE): According to another embodiment, the Architecture Instantiation Engine receives the encoded architecture representation from the MCN and dynamically constructs a computational graph executable on the target framework, such as TensorFlow, PyTorch, or ONNX-compatible back-ends. The engine ensures interoperability between hardware accelerators (GPUs, TPUs, NPUs) and software platforms.

The AIE also integrates a resource-aware compiler that translates high-level architectural descriptions into optimized low-level computation graphs. For example, the compiler may fuse convolution and batch-normalization layers or quantize activations for mobile deployments. The resource manager tracks GPU memory, CPU load, and execution latency to provide performance feedback to the meta-controller. Performance Evaluator Module (PEM): According to one embodiment of the invention, the Performance Evaluator Module (PEM) functions as an objective measurement environment that determines how effectively a candidate architecture performs on a given task. The PEM executes a partial training cycle for each generated model using a limited subset of training data and a small number of epochs to reduce computational cost.

During evaluation, multiple performance indicators are computed, including:
Validation accuracy or F1 score
Training loss curve slope (for convergence speed)
Computational complexity in floating-point operations (FLOPs)
Model size and parameter count
Energy consumption per training iteration
Inference latency and throughput on target device
Generalization error on hold-out data

These metrics are aggregated using a multi-objective scoring function to yield a single composite reward. The PEM also implements a predictive evaluator based on surrogate modeling (e.g., Gaussian Process or Bayesian regression) that estimates performance of partially trained models, further improving efficiency.

Adaptive Reward Engine (ARE): According to another embodiment, the Adaptive Reward Engine (ARE) introduces a dynamic reward formulation that continuously adjusts the optimization objective of the system. Traditional NAS methods rely on static metrics such as validation accuracy. In contrast, the ARE evaluates multi-dimensional trade-offs among performance, efficiency, robustness, and resource utilization.

For instance, in one example, the reward function R may be defined as:
R=α×Accuracy+β×Efficiency+γ×Robustness−δ×Energy
where coefficients α, β, γ, δ are dynamically tuned according to external constraints or user preferences. The ARE learns optimal weighting using reinforcement signals from higher-level performance goals. This enables context-sensitive optimization—e.g., prioritizing low latency for real-time robotics while emphasizing accuracy for medical diagnostics.

Self-Evolution Module (SEM): According to yet another embodiment, the Self-Evolution Module (SEM) is responsible for long-term adaptation of the meta-controller itself. It maintains a population of MCN variants, each representing a unique policy configuration. The SEM performs evolutionary operations such as:
Mutation: introducing random or gradient-guided perturbations into the MCN's weight parameters.
Crossover: combining parameter subsets between two parent controllers to generate a hybrid offspring.
Selection: retaining top-performing controllers based on historical fitness across multiple tasks.

Over generations, the SEM promotes survival of controllers that exhibit higher adaptability, thus achieving meta-level evolution. Unlike conventional genetic NAS systems, the SEM operates on meta-parameters rather than model parameters, leading to self-improvement in the learning strategy itself.

Reinforced Meta-Learning Mechanism: According to one embodiment, the invention employs a three-tiered learning hierarchy integrating reinforcement learning and meta-optimization:
1. Task Level (Inner Loop): A candidate neural architecture is instantiated and trained on a task (e.g., image classification). The obtained validation performance yields a reward.
2. Meta Level (Outer Loop): The meta-controller updates its policy parameters to maximize expected rewards over multiple tasks.
3. Evolutionary Level (Population Loop): A population of meta-controllers evolves over generations, enabling diversity and preventing premature convergence.

This hierarchical design ensures that the system not only identifies high-performing architectures for current data but also learns general strategies applicable to future unseen tasks.

Knowledge Memory and Meta-Experience Replay: According to one embodiment, a Knowledge Memory Unit (KMU) is embedded within the meta-learning system to record historical architecture-reward pairs and meta-controller trajectories. The KMU allows meta-experience replay, wherein past learning episodes are revisited to fine-tune the meta-policy.

The KMU stores:
Architecture encodings
Associated performance metrics
Environmental context variables (data type, device type, resource limits)
Temporal evolution records of controller updates

This memory enables transfer learning across tasks and avoids catastrophic forgetting. When faced with a new optimization problem, the system can retrieve relevant meta-experiences to initialize policy parameters close to optimal configurations.

Self-Evolving Mutation Dynamics: According to another embodiment, the mutation dynamics in the SEM are not purely random but informed by meta-gradients and performance feedback. Three mutation categories are defined:
1. Random Mutation: introduces stochastic perturbations within a bounded range to explore new strategies.
2. Directional Mutation: applies gradient-based nudges toward performance-increasing regions.
3. Contextual Mutation: triggers parameter changes only when significant task drift or performance degradation is detected.

A control gate driven by the Adaptation Detector monitors the rate of change in performance metrics. When performance stagnates beyond a threshold, the gate activates the mutation process. This ensures efficient exploration without destabilizing converged solutions.

Continual Learning and Task Transfer: According to one embodiment of the invention, the system incorporates a continual learning pipeline that preserves previously acquired meta-knowledge while enabling adaptation to new tasks. The controller parameters are partitioned into:
Stable parameters representing core learning behavior.
Plastic parameters reserved for rapid adaptation.

An elastic weight consolidation (EWC) or synaptic intelligence mechanism ensures that knowledge important for old tasks is retained while learning new ones. Consequently, the invention prevents catastrophic forgetting—a common issue in lifelong learning systems.

The transfer process involves mapping features of new tasks to stored experience embeddings in the KMU. By leveraging similarity metrics (e.g., cosine similarity of feature distributions), the system identifies prior learning episodes relevant to the new task and initializes the meta-policy accordingly, drastically reducing training time.

Adaptive Environmental Awareness: In one embodiment, the system incorporates an Environmental Awareness Layer (EAL) that constantly monitors external variables such as dataset drift, computational budget, or user-specified constraints. The EAL feeds contextual information into the ARE to dynamically modify reward weighting and policy update frequency.

For example, under resource scarcity, the system shifts focus from model accuracy to energy efficiency, automatically favoring lightweight architectures. Conversely, during high-availability phases, it explores more complex models. This environmental reactivity allows the invention to function autonomously in heterogeneous and unpredictable deployment environments.

Implementation Architecture: According to one embodiment, the framework is implemented in a modular microservice architecture comprising distributed nodes:
Controller Node: executes meta-controller networks and maintains communication with evaluation nodes.
Evaluation Node: trains candidate architectures and collects performance data.
Evolution Node: conducts population-based operations for self-evolution.
Reward Node: aggregates metrics and computes adaptive rewards.
Memory Node: stores historical meta-experiences in the KMU.

A message broker (e.g., Kafka, RabbitMQ) coordinates interactions among nodes. Containers (Docker/Kubernetes) allow the system to scale horizontally across multiple GPUs or edge devices. The system supports asynchronous updates, reducing latency and enabling real-time architecture evolution.

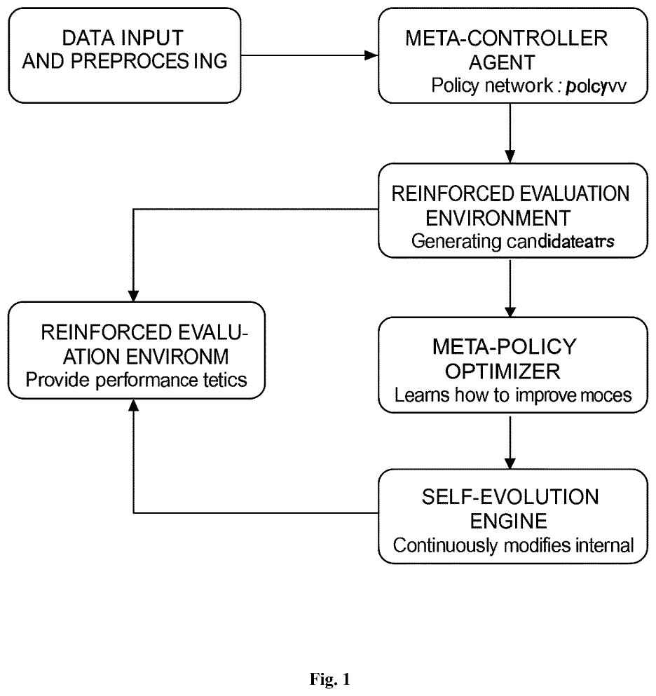

FIG. 1 illustrates the overall system architecture of the AI-Driven Adaptive Meta-Learning Framework for Self-Evolving Neural Architecture Optimization, in accordance with one embodiment of the present invention. The FIGURE comprises a flow diagram representing the sequential and feedback-based interaction among the major components of the system.

According to one embodiment of the invention, the process begins with a Data Input and Preprocessing Module, which receives raw or structured data from various sources and performs data normalization, augmentation, partitioning, and feature scaling to prepare input suitable for training neural architectures.

The preprocessed data is then provided to a Meta-Controller Agent, which serves as the policy network responsible for generating candidate neural network architectures.

The Meta-Controller uses reinforcement learning strategies to output encoded design configurations defining the number of layers, connectivity, activation functions, and optimization hyperparameters of the proposed architecture.

The generated architecture is then passed to a Reinforced Evaluation Environment, which performs a limited training cycle and evaluates the architecture on performance indicators such as accuracy, efficiency, energy consumption, and inference latency. The Reinforced Evaluation Environment computes composite performance metrics and transmits them as feedback to the Meta-Controller Agent.

A Meta-Policy Optimizer receives the performance results and reinforcement signals and updates the Meta-Controller's parameters using policy gradient or actor-critic learning mechanisms. The Meta-Policy Optimizer learns how to improve the controller's decision-making ability across multiple tasks and environments.

Subsequently, a Self-Evolution Engine continuously modifies internal parameters of the Meta-Controller by performing evolutionary operations, including mutation, crossover, and selection, based on historical performance and reward trajectories. This engine ensures long-term adaptation and continuous improvement in learning capability, forming a self-evolving intelligence loop.

The FIGURE also depicts a feedback arrow returning from the Self-Evolution Engine and Reinforced Evaluation Environment to the Data Input and Preprocessing stage, signifying that the framework operates in a closed-loop adaptive cycle, where model evolution is guided by environmental feedback, performance history, and resource constraints.

Through this cyclical and reinforced feedback mechanism, the invention enables autonomous design, evaluation, and evolution of neural network architectures that continuously improve their own learning strategies without human supervision.

### EXAMPLE USE CASES

### Example 1—Automated Model Design for Vision Tasks

According to one embodiment, the invention was used to evolve convolutional neural networks (CNNs) for image classification. The meta-controller progressively discovered novel hybrid architectures combining depthwise separable convolutions and dynamic attention layers, surpassing human-designed baselines with fewer parameters.

### Example 2—Edge-AI Deployment

In another embodiment, the framework optimized compact models for mobile object detection. The ARE prioritized energy efficiency, producing architectures 40% smaller while maintaining 95% accuracy compared to reference models.

### Example 3—Reinforced Robotics Learning

A further embodiment applied the invention to robotic vision and control. The system evolved reinforcement learning policy networks that adapted to new lighting and obstacle conditions in real time, illustrating continual self-evolution.

### Example 4—Medical Imaging Diagnostics

In yet another embodiment, the meta-learning framework adapted diagnostic neural networks for CT, MRI, and X-ray datasets. The adaptive reward engine automatically emphasized sensitivity and specificity metrics, improving clinical applicability.

### Example 5—Cybersecurity Threat Detection

Another embodiment used the invention for evolving recurrent architectures detecting anomalies in network traffic. The controller self-adjusted to new malware signatures without retraining from scratch.

Synergistic Effects: The synergistic integration of reinforcement, evolution, and meta-learning yields outcomes superior to each component in isolation. Reinforcement ensures local task optimization; evolution ensures global exploration; meta-learning ensures transferability. The combined system achieves exponential efficiency gains and continuous self-improvement—hallmarks of artificial meta-intelligence.

According to one embodiment, the system supports federated meta-learning, wherein multiple distributed clients perform local architecture search and periodically synchronize meta-controllers through a central coordinator. This design enhances data privacy and scalability across organizations while preserving adaptive evolution benefits.

### INDUSTRIAL APPLICATIONS

According to one embodiment, the invention is applicable to:
Autonomous vehicles adapting perception networks to weather and terrain.
Smart manufacturing predicting process anomalies using evolving neural predictors.
Personalized recommendation systems continuously adapting to user behavior.
Drug discovery models evolving with molecular database expansion.
Energy grid management optimizing neural controllers for dynamic loads.

The present invention, through its unique combination of reinforced meta-learning and self-evolutionary optimization, represents a pioneering advancement toward self-developing artificial intelligence. It establishes a foundation for intelligent systems capable of learning, adapting, and improving their own learning algorithms without external supervision.

It will be recognized that the above described subject matter may be embodied in other specific forms without departing from the scope or essential characteristics of the disclosure. Thus, it is understood that, the subject matter is not to be limited by the foregoing illustrative details, but it is rather to be defined by the appended claims. While specific embodiments of the invention have been shown and described in detail to illustrate the novel and inventive features of the invention, it is understood that the invention may be embodied otherwise without departing from such principles.

What is claimed is:

1. An adaptive self-evolving neural architecture optimization system comprising:

2. The system as claimed in claim 1, wherein the meta-controller network employs a reinforcement learning policy gradient to optimize architecture generation strategy.

3. The system as claimed in claim 1, wherein the adaptive reward engine utilizes Pareto-based multi-objective optimization balancing accuracy and efficiency.

4. The system as claimed in claim 1, wherein the self-evolution module performs neural crossover and mutation operations on meta-controller weights.

5. The system as claimed in claim 1, wherein the framework supports continual learning by reusing meta-knowledge from prior tasks.

6. The system as claimed in claim 1, wherein the reinforcement signal comprises both short-term and long-term returns.

7. The system as claimed in claim 1, wherein the invention is implemented through a distributed computing environment or edge-AI platform.

8. The system as claimed in claim 1, wherein the framework autonomously modifies architecture search policies based on environmental feedback.

9. A method for adaptive self-evolving neural architecture optimization comprising:

10. The method as claimed in claim 9, wherein the architecture search and meta-learning occur concurrently to enable real-time adaptation.
